(19) United States
(12) Patent Application Publication
(10) Pub. No.: US 2007/0230217 A1
(43) Pub. Date: Oct. 4, 2007

(54) Back light unit and liquid crystal display device

(75) Inventor: Yoshinobu Sakaki, Kanagawa (JP)

Correspondence Address: YOUNG & THOMPSON, 745 SOUTH 23RD STREET, 2ND FLOOR, ARLINGTON, VA, 22202, US

(73) Assignee: NEC LCD TECHNOLOGIES, LTD., Kanagawa (JP)

(21) Appl. No.: 11/727,254

(22) Filed: Mar. 26, 2007

(30) Foreign Application Priority Data
Mar. 29, 2006 (JP) 2006-091252

(51) Int. Cl. F21V 7/04

(52) U.S. Cl. 362/624; 362/609

(57) ABSTRACT

Provided is a back light unit of an edge light type, including at least a light guiding plate, a lamp, a reflection sheet and a reflector. The lamp is disposed on the side surface side of the light guiding plate. The reflection sheet is disposed on the back surface side of the light guiding plate. The reflector supports the reflection sheet from the back surface of the reflection sheet, and reflects light from the lamp towards the light guiding plate. The back light unit has a structure in which the reflection sheet is caused to come into contact with a ridge where the side surface of the light guiding plate and the back surface thereof meet, by curving an end of the reflection sheet on the side of the light source towards the side of the light guiding plate.

### BACKGROUND OF THE INVENTION

1. Field of the Invention

The present invention relates to a back light unit and a liquid crystal display device and, particularly, to a back light unit of an edge light type and a liquid crystal display device including the back light unit.

2. Description of the Related Art

A liquid crystal display (abbreviated as LCD) device has been widely used for office automation (abbreviated as OA) equipment, a television display or the like since the LCD device has the features of a small size, a thin shape and low power consumption. An LCD device includes a liquid crystal display (LCD) panel and a back light (abbreviated as BL) unit and the like. The LCD panel is formed by sandwiching a liquid crystal layer between transparent substrates facing each other, and the BL unit generates backlight for illuminating the LCD panel. Moreover, the BL unit for the LCD panel includes the following three types: a direct-irradiation type, an edge light type and a surface light source type. In the direct-irradiation type, light sources are disposed on the side of the back surface of an LCD panel, and light emitted from the light sources is reflected on a reflecting plate to illuminate the back surface of the LCD panel. In the edge light type, light sources are disposed along the side surface of an LCD panel, and light emitted from the light sources is guided to the entire back surface of the LCD panel with a light guiding plate to illuminate the back surface of the LCD panel. In the surface light source type, a surface light source is disposed on the entire back surface of an LCD panel to illuminate the back surface of the LCD panel. The edge light type is also referred to as a side light type. For devices which are required to be thin, LCD devices of the edge light type are generally used.

As shown in FIG. 16, a BL unit of an edge light type includes a light guiding plate 102, light sources such as cold cathode fluorescent lamps 103, a U-shaped reflector 104, a reflection sheet 105 and the like. The light guiding plate 102 is made of transparent plastic resin such as acrylate resin. The cold cathode fluorescent lamps 103 are disposed on a side of the light guiding plate 102. The reflector 104 has a function for reflecting light emitted from the cold cathode fluorescent lamp 103 to the light guiding plate 102. The reflection sheet 105 is disposed on the back surface of the light guiding plate 102, and reflects light leaked through the light guiding plate 102 to re-enter the light guiding plate 102. Such a BL unit of the edge light type is proposed, for example, in Japanese Laid-Open Patent No. 2002-245826.

In recent years, there has been a tendency that the display area of an LCD device is increased. Accordingly, components of the LCD device also become larger in size, leading to increase in the absolute values of dimensional tolerances. For this reason, after assembling components into a product, unexpected gaps are sometimes formed between components. These gaps result in a problem that bright lines and non-uniformity of luminance occur.

For example, in the case of the conventional BL unit 101 shown in FIG. 16, a gap is sometimes formed between the light guiding plate 102 and the reflection sheet 105 due to variation in the sizes of components forming the LCD device. When such a gap is formed, a diffuse reflection of light occurs on a ridge line of the light guiding plate 102. As a result, bright lines and non-uniformity of luminance occur in a vicinity of the cold cathode fluorescent lamp 103.

Moreover, the above-disclosed gap is sometimes formed when the LCD is subjected to vibration or impact. For example, such vibration or impact accidentally occurs while a product is transported. Accordingly, a problem occurs that the reliability of the LCD device is reduced.

### SUMMARY OF THE INVENTION

Accordingly, an exemplary feature of the invention is to provide a BL unit and an LCD device including the BL unit, which are capable of preventing occurrences of bright lines and non-uniformity of luminance attributable to a gap between components, in particular, a gap between a light guiding plate and a reflection sheet, and which are thus capable of enhancing display quality and reliability.

A BL unit of the present invention includes a plate-like light guiding plate, a light source, a reflection sheet, a reflector and a contacting member. The light source is disposed on a side surface of the light guiding plate. The reflection sheet is disposed on a back surface of the light guiding plate, and has an end of the reflection sheet on the side of the light source protruding from the edge of the light guiding plate. The reflector supports the reflection sheet from the side of the back surface of the reflection sheet, and reflects light emitted from the light source towards the side of the light guiding plate. The contacting member causes the reflection sheet to come into contact with a ridge where the side surface of the light guiding plate and the back surface thereof meet, by curving the end of the reflection sheet on the side of the light source towards the side of the light guiding plate.

An LCD device of the invention includes a LCD panel, a BL unit of an edge light type and a frame. The BL unit irradiates the LCD panel with backlight. The frame houses the LCD panel and the BL unit. The BL unit includes a plate-like light guiding plate, a light source, a reflection sheet, a reflector and a contacting member. The light source is disposed on a side surface of the light guiding plate. The reflection sheet is disposed on a back surface of the light guiding plate, and has the end protruding from the edge of the light guiding plate. The reflector supports the reflection sheet from the side of the back surface of the reflection sheet, and reflects light emitted from the light source towards the side of the light guiding plate. The contacting member causes the reflection sheet to come into contact with a ridge where the side surface of the light guiding plate and the back surface thereof meet, by curving the end of the reflection sheet on the side of the light source towards the side of the light guiding plate.

It is preferable that the contacting member be a convex part protruding towards the reflection sheet, which convex part is provided to the reflector in the vicinity of an end of the reflection sheet on the side of the light source.

It is preferable that the convex part be formed as continuing along a direction in which the light source extends.

It is preferable that the convex part be formed of a plurality of convex parts which are disposed as being spaced apart from one another along the direction in which the light source extends.

It is preferable that the shape of the cross-section of the convex part be any one of a semicircle, a polygon and a triangle.

It is preferable that the convex part is formed by providing a plurality of rows of convex parts different in size from one another.

It is preferable that the contacting member be a spacer fixed to any one of the reflector and the reflection sheet.

It is preferable that the shape of the cross-section of the spacer fixed to the reflector be any one of a semicircle and a polygon.

It is preferable that the shape of the cross-section of the spacer fixed to the reflection sheet be a polygon.

It is preferable that the spacer is formed by providing a plurality of rows of spacers different in size from one another.

It is preferable that the contacting member be pushing means inserted from the back surface side of the reflector.

It is preferable that the pushing means be formed of a screw or a pin inserted from the back surface side of the reflector.

It is preferable that the contacting member be a bent part, which is provided to the end of the reflection sheet on the side of the light source, and which is curved towards the side of the light guiding plate.

It is preferable that the bent part is formed by bending the reflection sheet a plurality of times.

A BL unit and an LCD device including the BL unit, which are capable of preventing occurrences of bright lines and non-uniformity of luminance attributable to a gap between components, in particular, a gap between a light guiding plate and a reflection sheet, and which are thus capable of enhancing display quality and reliability. According to the BL unit and the LCD device, it is possible to prevent occurrences of bright lines and non-uniformity of luminance attributable to a gap between components, in particular, a gap between a light guiding plate and a reflection sheet, and to thus enhance display quality and reliability.

The reason why it is possible is as follows. The BL unit of the edge light type has the following structure. The light source is disposed on the side surface of the light guiding plate. In addition, the reflection sheet is disposed on the back surface of the light guiding plate. Moreover, the light source and the reflection sheet are held by the reflector which reflects light from the light source to the light guiding plate. In the BL unit of this structure, the contacting member which causes the reflection sheet to come into contact with the ridge of the light guiding plate. With this structure, the reflection sheet is forcibly caused to come into contact with the light guiding plate, and thereby a gap between the light guiding plate and the reflection sheet is eliminated. As a result, it is possible to cause the ridge of the light guiding plate to be constantly in contact with the reflection sheet, even in a case where variation occurs in dimensions of components forming the LCD device, such as variation in the thickness of the light guiding plate, or even in a case where the LCD is subjected to a vibration and/or impact while being transported or the like.

### BRIEF DESCRIPTION OF THE DRAWINGS

These and other objects and advantages and further description of the invention will be more apparent to those skilled in the art by reference to the description, taken in connection with the accompanying drawings, in which:

FIG. 1 is a perspective view of a BL unit of a first exemplary embodiment of the present invention;

FIG. 2 is a sectional view taken along the I-I line in FIG. 1;

FIG. 3 is a sectional view showing a structure in a vicinity of a cold cathode fluorescent lamp of the BL unit of the first exemplary embodiment of the present invention;

FIG. 4 is a perspective view showing a reflector of the BL unit of the first exemplary embodiment of the present invention;

FIG. 5 is a perspective view showing another reflector of the BL unit of the first exemplary embodiment of the present invention;

FIG. 6 is a sectional view showing another structure in the vicinity of the cold cathode fluorescent lamp of the BL unit of the first exemplary embodiment of the present invention;

FIG. 7 is a sectional view for showing another structure in the vicinity of the cold cathode fluorescent lamp of the BL unit of the first exemplary embodiment of the present invention;

FIG. 8 is a sectional view showing a structure in a vicinity of a cold cathode fluorescent lamp of a BL unit of a second exemplary embodiment of the present invention;

FIG. 9 is a sectional view showing another structure in the vicinity of the cold cathode fluorescent lamp of the BL unit of a second exemplary embodiment of the present invention;

FIG. 10 is a sectional view showing another structure in the vicinity of a cold cathode fluorescent lamp of the BL unit of a second exemplary embodiment of the present invention;

FIG. 11 is a sectional view showing another structure in the vicinity of the cold cathode fluorescent lamp of the BL unit of a second exemplary embodiment of the present invention;

FIG. 12 is a sectional view showing another structure in the vicinity of the cold cathode fluorescent lamp of the BL unit of a second exemplary embodiment of the present invention;

FIG. 13 is a sectional view showing a structure in the vicinity of a cold cathode fluorescent lamp of a BL unit of a third exemplary embodiment of the present invention;

FIG. 14 is a sectional view showing another structure in the vicinity of a cold cathode fluorescent lamp of the BL unit of a third exemplary embodiment of the present invention;

FIG. 15 is a sectional view of an LCD device using the BL unit of the exemplary embodiment of the present invention; and

FIG. 16 is a sectional view for showing a structure in a vicinity of a cold cathode fluorescent lamp of a conventional BL unit.

### DETAILED DESCRIPTION OF THE PREFERRED EMBODIMENTS

Next, preferred embodiments of the present invention are described with reference to the accompanying drawings. In the preferred embodiments, a BL unit of an edge light type of the present invention includes, at least, a light guiding plate, light sources, a reflection sheet and a reflector. The light sources are disposed along the side surface of the light guiding plate. The reflection sheet is disposed on the back surface side of the light guiding plate. The reflector supports the reflection sheet from the back surface thereof, and covers the light sources at the same time so that light from the light sources can be reflected on the light guiding plate.

By including a contacting member with which the reflection sheet comes into contact with a ridge of the light guiding plate, an occurrence of a diffuse reflection of light on the ridge is suppressed. This makes it possible to prevent occurrences of bright lines and non-uniformity of luminance of the BL unit that may occur. Moreover, providing of such a BL unit enhances display quality and reliability of LCD devices. A specific description of the above-described contacting member is given below.

### First Exemplary Embodiment

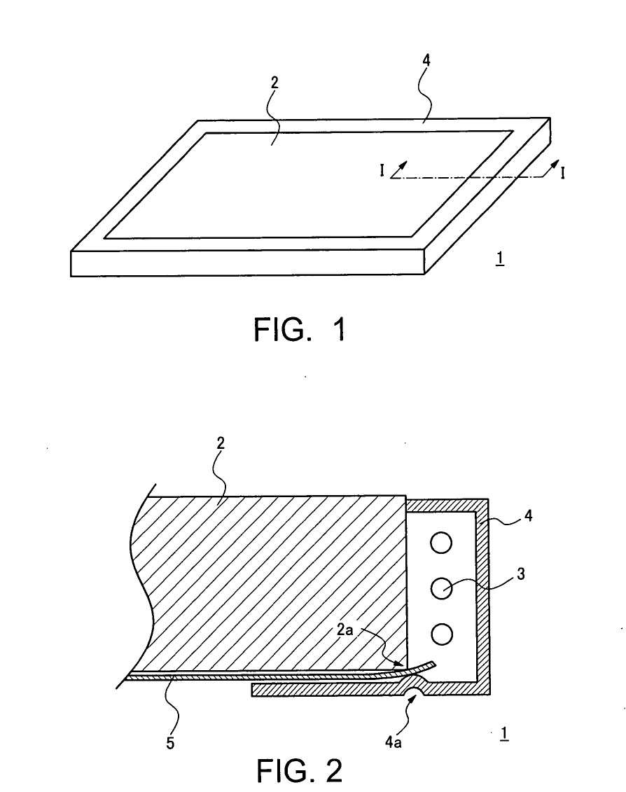

A BL unit according to a first exemplary embodiment of the present invention and an LCD device including the BL unit are described with reference to FIGS. 1 to 7, and 15.

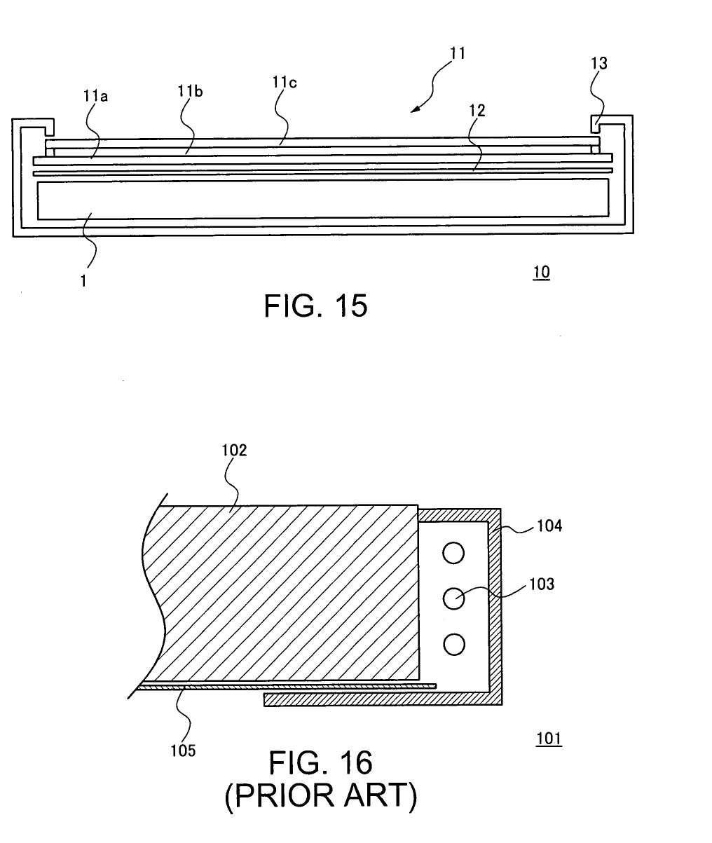

As shown in FIG. 15, an LCD device 10 includes an LCD panel 11 (regardless of shape, structure and driving system thereof), a BL unit 1 of the edge light type, the optical sheet 12 and a frame 13. The BL unit 1 is disposed under the back surface of the LCD panel 11, and emits backlight to illuminate the LCD panel 11. The optical sheet 12 is inserted between the LCD panel 11 and the BL unit 1. The frame 13 houses the LCD panel 11, the optical sheet 12 and the BL unit 1.

The LCD panel 11 is formed by sandwiching a liquid crystal layer 11c between a first substrate 11a and a second substrate 11b. In the first substrate 11a, switching elements such as thin film transistors (abbreviated as TFTs) are formed in pixels being arranged in matrix, respectively. In the second substrate 11b, color filters, black matrix and the like are formed. To the first substrate 11a, a flexible printed circuit (abbreviated as FPC) is connected, so that the first substrate 11a is connected to an outer circuit board such as a control circuit board for controlling the LCD panel 11. Although not shown, the FPC is folded back over the back surface (a surface opposite to the front surface) of the BL unit 1.

As shown in FIGS. 1 and 2, the BL unit 1 includes a light guiding plate 2, light sources, a reflection sheet 5 and a reflector 4. The light guiding plate 2 is made of transparent plastic resin such as acrylate resin or the like. As the light sources (hereinafter, referring to cold cathode fluorescent lamps 3), one or a plurality of cold cathode fluorescent lamps or light emitting diodes (LEDs) may be used. The reflection sheet 5 is disposed on the side of the back surface (a non-light emitting surface) of the light guiding plate 2. Moreover, the reflection sheet 5 reflects light leaking through the light guiding plate 2 causing the leaking light to re-enter the light guiding plate 2 so that efficiency in use of light can be enhanced. The reflector 4 is formed into a U-shape in a manner that the reflector 4 supports the reflection sheet 5 from the back surface thereof, and that the reflector 4 covers the cold cathode fluorescent lamps 3. Thereby the reflector 4 reflects light emitted from the cold cathode fluorescent lamps 3 to the side of the light guiding plate 2.

The above-described reflector 4 is formed mainly of a composite material in which a white plastic film is pasted on a metal plate. In addition, the reflector 4 is configured so as to effectively cause light emitted from the cold cathode fluorescent lamps 3 to enter the light guiding plate 2. The reflection sheet 5 is formed mainly of a white plastic film. In addition, the reflection sheet 5 is configured to have external dimensions larger than those of the light guiding plate 2 so as to protrude from the edge of the light guiding plate 2. Thereby, light leaking through the light guiding plate 2 can be securely reflected.

The optical sheet 12 is formed of a single sheet or a plurality of stacked sheets including a diffusing sheet for causing backlight emitted from the light guiding plate 2 to be uniform, a lens sheet or a polarizing sheet which focuses backlight to enhance luminance; or the like. The optical sheet 12 is disposed on the light guiding plate 2, and can be incorporated in the BL unit 1.

Note that, the present invention has a feature in a structure of the back surface side of the BL unit 1. The configurations, dispositions and dimensions of other parts (the light guiding plate 2, the light source, the LCD panel and the like) can be freely designed. In addition, the present invention can be applied to any of edge light types. For example, the present invention can be applied to a structure in which the cold cathode fluorescent lamps 3 are disposed respectively on two sides of the light guiding plate 2, which two sides face each other.

Hereinafter, an area in which a surface of the light guiding plate 2 on the side of the cold cathode fluorescent lamps 3 meets a surface thereof on the side of the reflection sheet 5 is referred to as a ridge 2a. The BL unit 1 of the LCD device of the above-described configuration is provided with a contacting member which forcibly causes the ridge 2a of the light guiding plate 2 and the reflection sheet 5 to come into contact with each other.

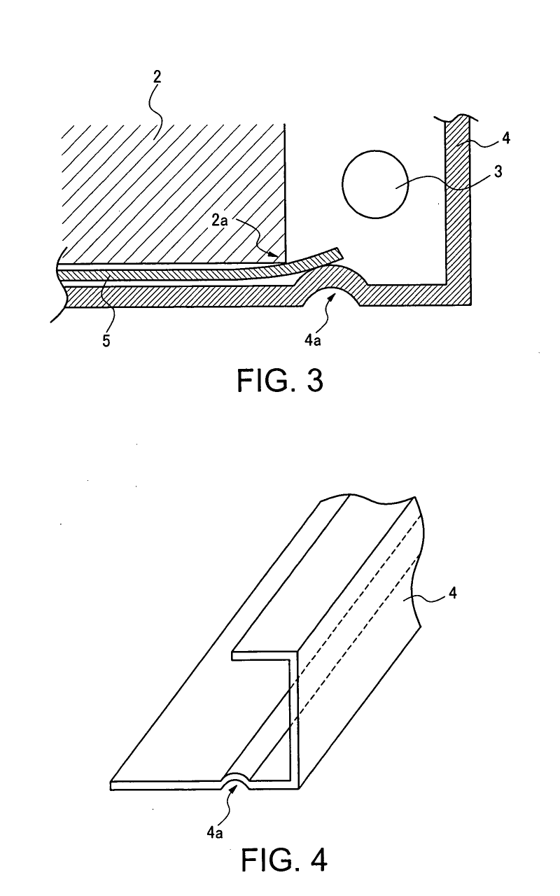

In the present embodiment, as one example of the contacting member, as shown in FIGS. 2 and 3, a convex part 4a protruding towards the reflection sheet 5 is provided to the reflector 4 in a vicinity of an end of the reflection sheet on the side of the light sources. The convex part 4a can be formed by processing the reflector 4 such as bending or squeezing. In the BL unit 1 formed in the way described above, the end of the reflection sheet 5 on the side of the light sources, which protrudes from the edge of the light guiding plate 2, is lifted by the convex part 4a, and is curved towards the side of the light guiding plate 2. As a result, the ridge 2a of the light guiding plate 2 and the reflection sheet 5 are caused to forcibly come into contact with each other.

Note that, the size of the convex part 4a is not limited to the configuration shown in FIGS. 2 and 3. The size of the convex part 4a may be adjusted appropriately, according to the dimensional accuracies of the respective components. For example, in a case where a gap between the reflector 4 and the reflection sheet 5 is large or a case where a gap between the reflection sheet 5 and the light guiding plate 2 is large, the convex part 4a may be enlarged. In addition, it is only necessary to form the convex part 4a so that the convex part 4a comes into contact with a part of the reflection sheet 5, which part protrudes from the edge of the light guiding plate 2, and the position of the convex part 4a can be adjusted as needed.

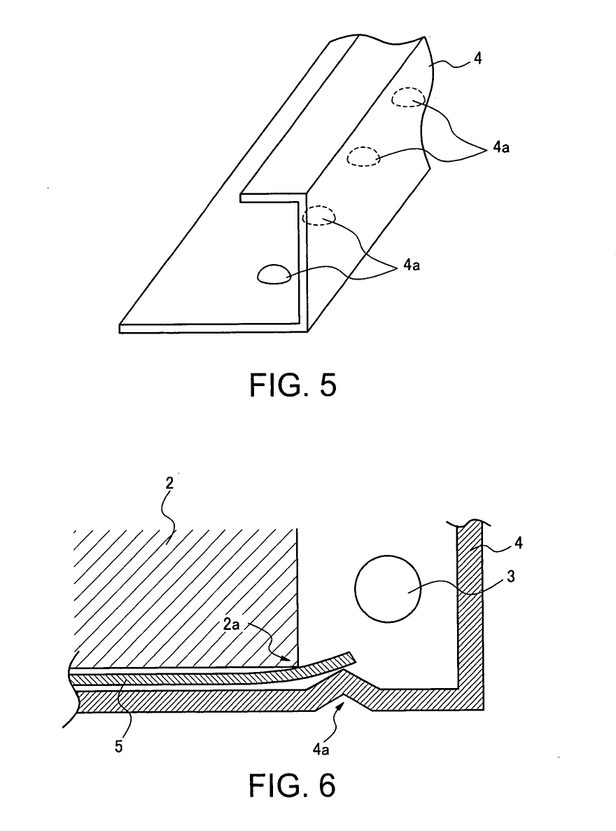

Moreover, for the purpose of causing the convex part 4a to be in contact with the reflection sheet 5 along the entire length of the ridge 2a of the light guiding plate 2, it is preferable that the convex part 4a be formed as continuing along a direction in which the cold cathode fluorescent lamps 3 extend (depth direction perpendicular to the drawing sheet, and hereinafter the direction is referred to as the extending direction), as shown in FIG. 4. That is, as the contacting member which forcibly causes the ridge 2a of the light guiding plate 2 and the reflection sheet 5 to come into contact with each other, the convex part 4a, which is formed as continuing along the extending direction of the cold cathode fluorescent lamps 3, is used. In a case where the reflection sheet 5 has an appropriate rigidity, for example, as shown in FIG. 5, a plurality of the convex parts 4a may be disposed as being spaced one another along the extending direction of the cold cathode fluorescent lamps 3. That is, as the contacting member which forcibly causes the ridge 2a of the light guiding plate 2 and the reflection sheet 5 to come into contact with each other, the plurality of the convex parts 4a, which are formed as being spaced one another along the extending direction of the cold cathode fluorescent lamps 3, may also be used.

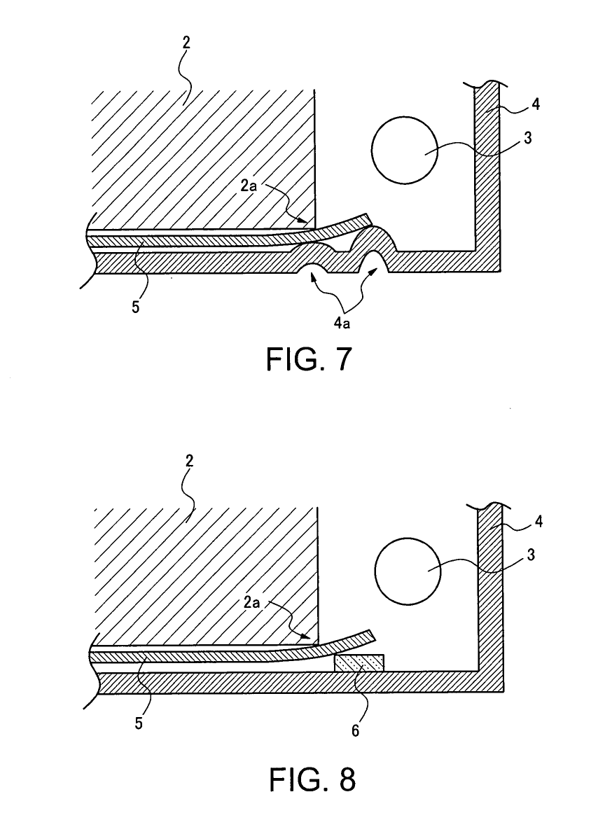

Although the cross-section of each of the convex parts 4a shown in FIGS. 2 to 4 is semicircular, the convex part 4a may be in any shape. For example, the convex part 4a may be formed to have a polygonal cross-section. As an example of the convex part 4a having a polygonal cross-section, one having a triangular cross-section is shown in FIG. 6. In addition, the convex part 4a may be formed to have a rectangular cross-section. Moreover, although each of FIGS. 2 to 4 and 6 shows a structure in which a single convex part 4a is provided along the extending direction of the cold cathode fluorescent lamps 3, a plurality of convex parts 4a which are different in size and/or shape from one another may be formed as shown in FIG. 7. With this structure, the reflection sheet 5 is moderately curved. A smaller convex part 4a is disposed in a position on the closer side to the ridge 2a of the light guiding plate 2, and a larger convex part 4a is disposed in a position on the farther side therefrom. Thereby, the reflection sheet 5 can be moderately curved.

As described above, in the BL unit 1 of the present invention, the end of the reflection sheet 5, which end protrudes from the edge of the light guiding plate 2 to the side of the light sources, is lifted by the convex part 4a formed on the reflector 4 so as to be curved. This makes it possible to cause the ridge 2a of the light guiding plate 2 and the reflection sheet 5 to be constantly in contact with each other. Accordingly, an occurrence of a diffuse reflection of light on the ridge 2a of the light guiding plate 2 can be suppressed. Thereby, bright lines and non-uniformity of luminance can be prevented from occurring. As a result, by providing of the BL unit 1, display quality and reliability of an LCD device can be enhanced.

### Second Exemplary Embodiment

Next, a BL unit of a second exemplary embodiment of the present invention and an LCD device including the BL unit are described with reference to FIGS. 8 to 12.

In the above-described first exemplary embodiment, as the contacting member which forcibly causes the ridge of the light guiding plate and the reflection sheet to come into contact with each other, the reflector 4 is processed so as to form the convex part 4a, and the end of the reflection sheet 5 on the side of the light sources is curved towards the side of the light guiding plate 2 by the convex part 4a. However, a means by which the reflection sheet 5 is curved is not necessarily integrally formed in the reflector 4, and may be separately formed as another part.

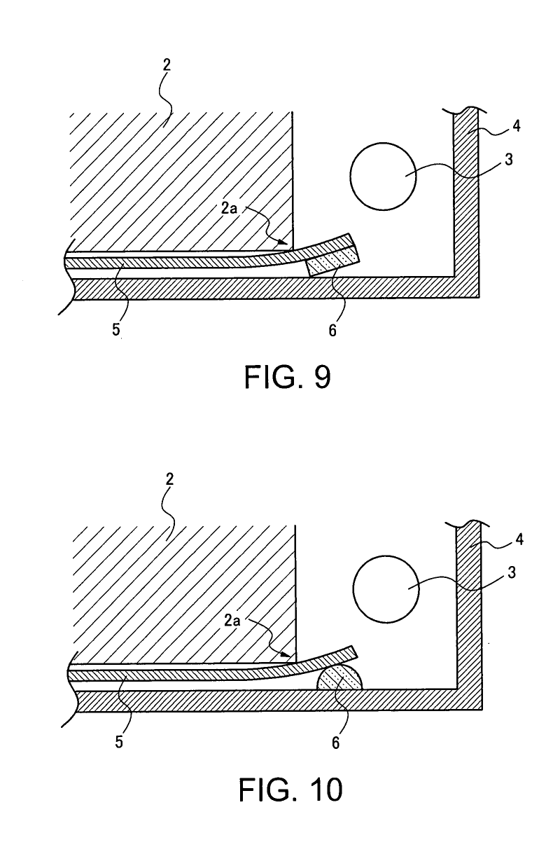

For example, as a contacting member, as shown in FIG. 8, a spacer 6 made of plastic resin, rubber, metal or the like may be fixed on a reflector 4 using an adhesive or the like along an edge of the reflection sheet 5 on the side of light sources. By causing the spacer 6 to lift the edge of the reflection sheet 5 on the side of light sources, the same effect as that produced by the above-described convex part 4a can be produced as well. Moreover, as shown in FIG. 9, by pasting the spacer 6 with an adhesive along the edge of the reflection sheet 5 on the side of the light sources, the same effect as that produced by the above-described convex part 4a can be produced as well.

Note that, the size of the spacer 6 is not limited to the configuration shown in FIGS. 8 and 9. The size of the convex part 4a may be adjusted appropriately, according to the dimensional accuracies of the respective components. In addition, it is only necessary to dispose the spacer 6 so that the spacer 6 comes into contact with a part of the reflection sheet 5, which part protrudes from the edge of the light guiding plate 2, and the position of the spacer 6 can be adjusted as needed.

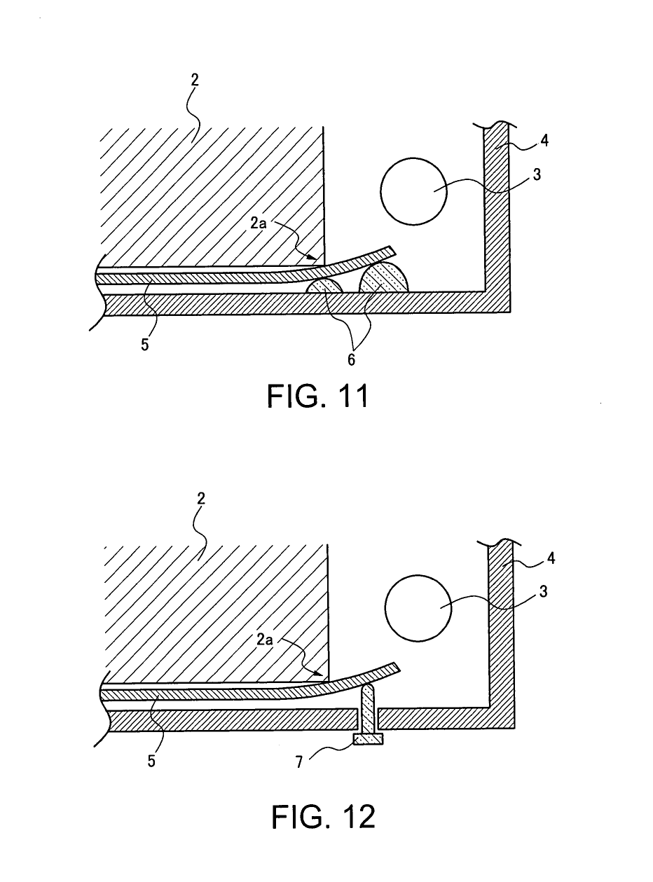

In addition, it is preferable that the spacer 6 be disposed as continuing along the extending direction of the cold cathode fluorescent lamps 3. However, as in the case of the first exemplary embodiment, in a case where the reflection sheet 5 has an appropriate rigidity, a plurality of the spacers 6 may be disposed as being spaced one another. Moreover, any number of the spacers 6 of any shape may be disposed. For example, as shown in FIG. 10, the cross-section of each of the spacer 6 may be semicircular, polygonal, rectangular or the like. For the purpose of moderately curving the reflection sheet 5, a plurality of the spacers 6 which are different in size and/or shape from one another may be formed as shown in FIG. 11. With this structure, the reflection sheet 5 is moderately curved. On the reflector 4, a smaller spacer 6 is disposed in a position on the closer side to the ridge 2a of the light guiding plate 2 and a large spacer 6 is disposed in a position on the farther side therefrom. Thereby, the reflection sheet 5 can be moderately curved.

Furthermore, as the contacting member which causes the ridge 2a of the light guiding plate 2 and the reflection sheet 5 to come into contact with each other, each of FIGS. 8 to 11 shows a structure in which the spacer 6 is disposed between the reflector 4 and the reflection sheet 5. However, for such a structure, a pushing means 7 such as a screw or a pin, which is inserted through the reflector 4 from the back surface thereof, may be used. By inserting such a pushing means 7, the end of the reflection sheet 5 on the side of the light sources may be pushed to be curved towards the side of the light guiding plate 2. By using a pushing means 7 having a screwing structure, the degree of curve of the reflection sheet 5 may be adjusted even after the BL unit 1 is assembled.

As described above, in the BL unit 1 of the present exemplary embodiment, the end of the reflection sheet 5, which end protrudes from the edge of the light guiding plate 2 towards the side of the light sources, is lifted by the spacer 6 disposed on the reflector 4, or is pushed up with the pushing means 7 so as to be curved. This makes it possible to cause the ridge 2a of the light guiding plate 2 and the reflection sheet 5 to be constantly in contact with each other. Accordingly, an occurrence of a diffuse reflection of light on the ridge 2a of the light guiding plate 2 can be suppressed. Thereby, bright lines and non-uniformity of luminance can be prevented from occurring. As a result, display quality and reliability of an LCD device can be enhanced.

### Third Exemplary Embodiment

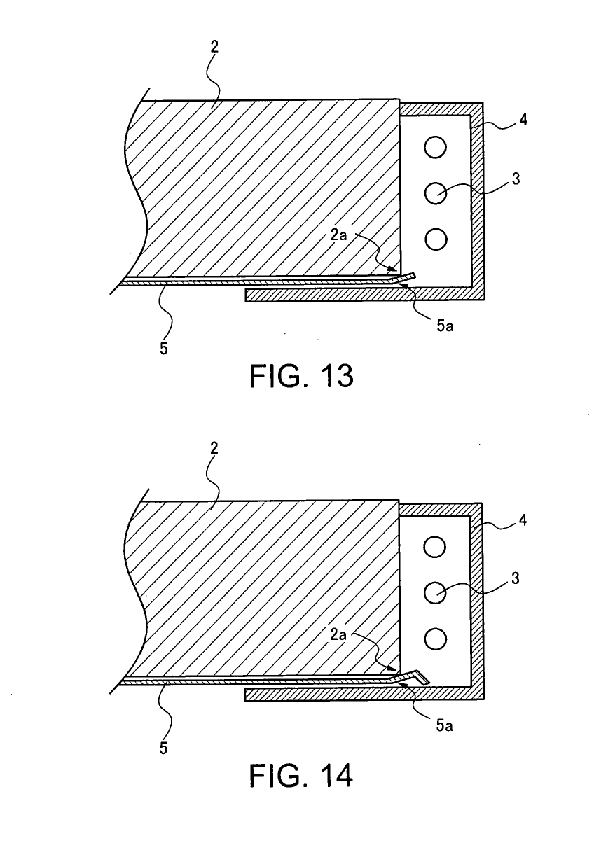

Next, a BL unit of a third exemplary embodiment of the present invention and an LCD device including the BL unit are described with reference to FIGS. 13 and 14.

In the above-described first exemplary embodiment, the reflector 4 is processed, and thereby the convex part 4a is formed. Moreover, in the second exemplary embodiment, the spacer 6 is disposed, or the pushing means 7 is inserted, between the reflector 4 and the reflection sheet 5. With the convex part 4a, the spacer 6 or the pushing means 7, the end of the reflection sheet 5 on the side of the light sources is curved towards the side of the light guiding plate 2. However, it is conceivable that it is difficult, in some cases, to form the convex part 4a on the reflector 4, to dispose the spacer 6 between the reflector 4 and the reflection sheet 5, or to insert the pushing means 7 into the reflector 4. The present embodiment is a contacting member for such cases, with which the ridge 2a of the light guiding plate 2 and the reflection sheet 5 are caused to come into contact with each other.

When the reflection sheet 5 is adequately stiff, the reflection sheet 5 may be bent in an arbitrary position in a vicinity of the end of the reflection sheet 5 on the side of the light sources as shown in FIG. 13. Thereby, a bent part 5a and the ridge 2a of the light guiding plate 2 are caused to come into contact with each other. In order to uniform the shape of the bent par 5a, the reflection sheet 5 may be bent a plurality of times on arbitrary positions in a vicinity of the end of the reflection sheet 5 on the side of the light sources as shown in FIG. 14. Thereby, an occurrence of a diffuse reflection of light on the ridge 2a of the light guiding plate 2 can be suppressed. Accordingly, bright lines and non-uniformity of luminance can be prevented from occurring. As a result, display quality and reliability of an LCD device can be enhanced.

The structures in the above-described respective embodiments may be used sorely or in an arbitrary combination. Each of the above-described embodiments has shown the structure of the BL unit 1, in which the convex part 4a, the spacer 6, the pushing means 7 or the bent part 5a is provided. However, the present invention is not limited to the above-described embodiments, and another structure may be employed in which the ridge 2a of the light guiding plate 2 and the reflection sheet 5 can be caused to come into contact with each other. In addition, although the shape of the light guiding plate 2 is not particularly described in the above-described embodiments, to be specific, it may be of a plate shape, a wedge shape or the like. Furthermore, although FIG. 1 has shown the reflector 4 of a frame shape as an example, the shape of the reflector 4 is not limited to this shape. It is only sufficient for the reflector 4 that the reflector 4 be disposed at least, in a region near the back surface of the light guiding plate 2, and in proximity to the light sources.

Although preferred embodiments of the invention have been described with reference to the drawings, it will be obvious to those skilled in the art that various changes or modifications may be made without departing from the true scope of the invention.

What is claimed is:

1. A back light unit comprising:
a plate-like light guiding plate;
a light source disposed on a side surface of the light guiding plate;
a reflection sheet disposed on a back surface of the light guiding plate, and having an end of the reflection sheet on the side of the light source protruding from the edge of the light guiding plate;
a reflector supporting the reflection sheet from the side of the back surface of the reflection sheet, and reflecting light emitted from the light source towards the side of the light guiding plate; and
a contacting member for causing the reflection sheet to come into contact with a ridge where the side surface of the light guiding plate and the back surface thereof meet, by curving the end of the reflection sheet on the side of the light source towards the side of the light guiding plate.

2. The back light unit according to claim 1, wherein the contacting member is a convex part protruding towards the reflection sheet, which convex part is provided to the reflector in a vicinity of the end of the reflection sheet on the side of the light source.

3. The back light unit according to claim 2, wherein the convex part is formed as continuing along a direction in which the light source extends.

4. The back light unit according to claim 2, wherein the convex part is formed of a plurality of convex parts which are disposed as being spaced apart from one another along a direction in which the light source extends.

5. The back light unit according to claim 2, wherein the shape of the cross-section of the convex part is any one of a semicircle, a polygon and a triangle.

6. The back light unit according to claim 2, wherein the convex part is formed by providing a plurality of rows of convex parts different in size from one another.

7. The back light unit according to claim 1, wherein the contacting member is a spacer fixed to any one of the reflector and the reflection sheet.

8. The back light unit according to claim 7, wherein the shape of the cross-section of the spacer fixed to the reflector is any one of a semicircle and a polygon.

9. The back light unit according to claim 7, wherein the shape of the cross-section of the spacer fixed to the reflection sheet is a polygon.

10. The back light unit according to claim 7, wherein the spacer is formed by providing a plurality of rows of spacers different in size from one another.

11. The back light unit according to claim 1, wherein the contacting member is pushing means inserted from the back surface side of the reflector.

12. The back light unit according to claim 11, wherein the pushing means is formed of at least any one of a screw and a pin inserted from the back surface side of the reflector.

13. The back light unit according to claim 1, wherein the contacting member is a bent part, which is provided to the end of the reflection sheet on the side of the light source, and which is curved towards the side of the light guiding plate.

14. The back light unit according to claim 13, wherein the bent part is formed by bending the reflection sheet a plurality of times.

15. A liquid crystal display device comprising:
a liquid crystal display panel;
a back light unit of an edge light type which unit irradiates the liquid crystal display panel with backlight; and
a frame which houses the liquid crystal display panel and the back light unit, wherein
the back light unit comprises:
a plate-like light guiding plate;
a light source being disposed on a side surface of the light guiding plate;
a reflection sheet disposed on a back surface of the light guiding plate, and having an end of the reflection sheet on the side of the light source protruding from the edge of the light guiding plate;
a reflector supporting the reflection sheet from the side of the back surface of the reflection sheet, and reflecting light emitted from the light source to the side of the light guiding plate; and
a contacting member for causing the reflection sheet to come into contact with a ridge where the side surface of the light guiding plate and the back surface thereof meet, by curving the end of the reflection sheet on the side of the light source towards the side of the light guiding plate.

16. The liquid crystal display device according to claim 15, wherein the contacting member is a convex part protruding towards the reflection sheet, which convex part is provided to the reflector in a vicinity of the end of the reflection sheet on the side of the light source.

17. The liquid crystal display device according to claim 16, wherein the convex part is formed as continuing along a direction in which the light source extends.

18. The liquid crystal display device according to claim 16, wherein the convex part is formed of a plurality of convex parts which are disposed as being spaced apart from one another along a direction in which the light source extends.

19. The liquid crystal display device according to claim 16, wherein the shape of the cross-section of the convex part is any one of a semicircle, a polygon and a triangle.

20. The liquid crystal display device according to claim 16, wherein the convex part is formed by providing a plurality of rows of convex parts different in size from one another.

21. The liquid crystal display device according to claim 15, wherein the contacting member is a spacer fixed to any one of the reflector and the reflection sheet.

22. The liquid crystal display device according to claim 21, wherein the shape of the cross-section of the spacer fixed to the reflector is any one of a semicircle and a polygon.

23. The liquid crystal display device according to claim 21, wherein the shape of the cross-section of the spacer fixed to the reflection sheet is a polygon.

24. The liquid crystal display device according to claim 21, wherein the spacer is formed by providing a plurality of rows of spacers different in size from one another.

25. The liquid crystal display device according to claim 15, wherein the contacting member is pushing means inserted from the back surface side of the reflector.

26. The liquid crystal display device according to claim 25, wherein the pushing means is formed of at least any one of a screw and a pin inserted from the back surface side of the reflector.

27. The liquid crystal display device according to claim 15, wherein the contacting member is a bent part, which is provided to the end of the reflection sheet on the side of the light source, and which is curved towards the side of the liquid guiding plate.

28. The liquid crystal display device according to claim 27, wherein the bent part is formed by bending the reflection sheet a plurality of times.
